(19) United States
(12) Patent Application Publication
(10) Pub. No.: US 2023/0411027 A1
(43) Pub. Date: Dec. 21, 2023

(54) CONTAINER FOR RADIOACTIVE WASTE

(71) Applicant: GNS GESELLSCHAFT FUR NUKLEAR-SERVICE MBH, Essen (DE)

(72) Inventors: Berthold KLOEHN, Witten (DE); Benjamin JECH, Dortmund (DE); Tobias FISCHER-WASELS, Essen (DE)

(21) Appl. No.: 18/036,839

(22) PCT Filed: Nov. 9, 2021
(86) PCT No.: PCT/EP2021/081078

§ 371 Date: May 12, 2023

(30) Foreign Application Priority Data
Dec. 17, 2020 (EP) 20214907.6

(51) Int. Cl. G21F 5/008; G21F 5/12

(52) U.S. Cl. CPC G21F 5/008; G21F 5/12

(57) ABSTRACT

The invention relates to a container for receiving radioactive waste materials, in particular for receiving spent fuel elements, comprising a container casing, a container base which is connected to the container casing, and at least one container cover. The container cover has at least One locking recess which is arranged its the edge region on the upper face of the cover. At least one locking element is arranged or at least one locking element can be arranged in the locking recess. The locking element has at feast one formfitting protrusion which is oriented in the direction of the container easing and which engages into a complementary formfitting recess of the container casing in the locked state of the container cover. The formfitting recess is arranged in the edge region of the container casing on the cover side.

The invention relates to a container for holding radioactive waste materials, in particular for holding spent fuel elements, with a container side wall, with a floor connected to the side wall and with at least one cover, the cover comprises at least one latch recess formed in an outer edge of the upper face of the cover, and at least one latch element is provided or can be provided in the latch recess. The invention further relates to a container assembly unit comprising a canister and a transport and/or storage container.

Containers of the above-described type are basically known from practice in different embodiments. In particular, canisters are known that are loaded with spent fuel elements under water and then closed with a cover. The canisters are subsequently accommodated in a transport and/or storage container. The load attachment point for the transfer of the canisters thereby required for the transfer into the transport and/or storage containers is usually provided in the cover upper face of the canister on account of the vertical handling of the canisters. The connection of the cover and canister must be designed accordingly for the load acting during the transfer into the transport and/or storage containers.

It is therefore known from practice to provide a weld seam between the canister cover and the canister side wall. The welding of the canister cover with the canister side wall has been thoroughly tried and tested. The tightness of the canister is usually also achieved by a weld ring as a tight weld seam. Such welds or tight weld seams can usually comply with the permissible leakage rates and have therefore also been thoroughly tried and tested.

The containers or canisters known from practice can however only be opened again with great effort on account of the weld seams. This is a drawback especially in the case of a required relocation of the fuel elements. A destruction-free reopening of the canisters known from practice that are welded, is not possible. Screw fasteners for canister covers of containers for holding radioactive waste materials are in fact known, but these screw fasteners require a large wall thickness of the containers or the side walls that cannot be achieved particularly for thin-walled containers, such as canisters for example.—In this regard, there is a need for improvement.

In contrast, the object of the invention is to provide a container of the type mentioned above that can be closed easily and functionally reliably, but nonetheless has an optimum tightness and complies with the permissible leakage rates, which is easy to handle and which moreover can be reopened safely and destruction-free with relatively little effort.

To attain this object, the invention teaches a container for holding radioactive waste materials, in particular for holding spent fuel elements, with a container side wall, with a floor connected to the side wall and with at least one cover, the cover comprises at least one latch recess formed in an outer edge of the upper face of the cover, and at least one latch element is provided or can be provided in the latch recess. The container according to the invention is characterised in that the latch element comprises at least one projection that extends toward the side wall and that engages in a complementary seat of the side wall when the cover is latched down, and the complementary seat is formed in the upper edge of the side wall.

It lies within the scope of the invention that the cover comprises latch recesses formed in the outer edge of the upper face of the cover, in which at least one respective latch element is provided or can be provided. The latched state of the cover is understood within the scope of the invention to mean in particular the state in which at least one form fitting projection of the at least one latch element engages in the at least one complementary seat of the side wall, so that a complementary interfit between the form fitting projection and the complementary seat is achieved. It lies within the scope of the invention that the cover when latched state is connected to the side wall in a form fitting manner on account of the form fitting interaction of the at least one form fitting projection of the latch element with the least one complementary seat of the side wall. When the cover is latched, the at least one form fitting projection of the latch element is expediently received in a form fitting manner in the complementary seat of the side wall, in particular fitted in the complementary seat.

According to a preferred embodiment of the container according to the invention, a carrier basket for holding the spent fuel elements is provided in the container interior of the container. The carrier basket preferably comprises individual holding tubes for the fuel elements. Furthermore, it lies within the scope of the invention that the floor and the side wall are connected to one another in one piece or are connected to one another by at least one weld joint.

A particularly preferred embodiment of the invention is characterised in that the container is a canister. The canister is preferably loaded with spent fuel elements under water, then closed with the cover and then transferred into a transport and/or storage container. In principle, the container can also be loaded dry.

Moreover, it lies within the scope of the invention that the container according to the invention or the side wall thereof is constituted cylindrical. The container according to the invention is preferably round in cross-section, preferably circular. The radial direction of the container is understood within the scope of the invention to mean expediently obliquely, in particular perpendicular to the longitudinal central axis L of a container preferably constituted round or circular in cross-section. In principle, other container geometries also lie within the scope of the invention, for example cornered, in particular rectangular and suchlike cross-sectional geometries of the container.

According to the invention, the cover comprises at least one latch recess that is formed in the outer edge of the upper face of the cover. At least one latch element is provided in the at least one latch recess, which latch element comprises at least one form fitting projection projects toward the side wall or the cover outer edge. The orientation of the form fitting projection of the latch element relates in particular to the state in which the latch element is provided in the latch recess. Within the scope of the invention, the form fitting projection is thus not part of the cover itself, but rather part of the latch element that is provided or can be provided according to the invention in the latch recess. The cover can expediently be connected to the side wall by the at least one latch element and in particular by the at least one form fitting projection of the latch element, in particular can be connected in a form fitting manner. It is recommended that the latched cover is connected to the side wall by the form fitting projection of the at least one connecting element, and in fact on account of the form fitting interaction of the form fitting projection with the at least one complementary seat.

If lies within the scope of the invention that the latch element in the unlatched state of the container can be displaced in the latch recess. Particularly preferably, the latch element in the unlatched state of the container can be displaced in the latch recess obliquely, in particular perpendicular to a longitudinal central axis L of the container, preferably radially of the container, so that it can be move between an open position into a form fitting position and back. Unlatched state of the container is understood within the scope of the invention to mean in particular the state in which the at least one latch element is not yet completely fixed in its form fitting position. The completely latched the container, on the contrary, is understood to mean the state in which the cover is connected with the side wall, in particular is connected in a form fitting manner by the latch element or the latch elements and in which the at least one latch element is fixed in its form fitting position.

The indication perpendicular to the longitudinal central axis L of the container relates moreover within the scope of the invention in particular to the vertical upright state of the container, in which the floor stands on a subsurface and the cover is provided above. In this vertical upright state, the longitudinal central axis of the container is upright. The at least one latch element or the latch elements can expediently be displaced in the latch recess or in the latch recesses perpendicular to the longitudinal central axis of the container in the unlatched state of the container. With regard to its dimensions or its diameter, the latch recess is thus preferably larger than the latch element. According to a preferred embodiment, when the container according to the invention is constituted as a cylinder with a circular cross-section, the at least one latch element can expediently be displaced radially of the container in the unlatched state of the container. As a result of the displacement of the at least one latch element obliquely, in particular perpendicular to the longitudinal central axis of the container, in particular radially of the container, the at least one latch element can preferably be move between an open position into a form fitting position and back.

It lies within the scope of the invention that the form fitting projection of the at least one latch element in the open position does not engage in the complementary seat of the side wall. The form fitting projection of the latch element expediently engages in a form fitting manner in the complementary seat after the displacement of the latch element into the latch recess in the direction of the container outer side and is then located in a form fitting position. When the at least one latch element is located in the form fitting position, in particular when all the latch elements are located in the form fitting position, the cover is latched. In the open position, it is recommended that the cover can be removed from the container and is unlatched. In the form fitting position, the cover can expediently not be removed from the side wall and is moreover preferably connected to the side wall in a twist-proof manner. The preferably provided displaceability of the latch element or the latch elements in the latch recess or in the latch recesses thus enables switching back and forth between the form fitting position and the open position, so that in particular reopening of the container is possible.

It is possible that the container is already present in the completely latched state due to the transfer or the arrangement of the latch elements in the form fitting position and thus in its latched state, in which the latch elements are fixed in their form fitting position. According to a very preferred embodiment, a holding element and/or a fixing element is additionally provided, in order to hold the latch element in its form fitting position and to produce the completely latched state of the cover. This is explained in greater detail below.

A preferred embodiment of the container according to the invention is characterised in that the container comprises a support ledge surrounding the inner face of the side wall, on which the cover can be placed. Expediently, the support ledge is provided in the upper edge of the side wall and preferably beneath the at least one complementary seat. The cover expediently comprises a complementary support shoulder for the support on the support ledge. The support ledge runs around the inner face of the side wall preferably up to at least 80%, preferably up to at least 90%. It is preferable that the support ledge running around the inner face is interrupted in sections, in order to enable the introduction of a carrier basket.

It lies within the scope of the invention that the cover upper face of the cover has a projecting end relative to the upper end of the side wall that projects beyond the upper end of the side wall when the cover is placed on the side wall and is in particular placed with its support shoulder on the support ledge of the side wall. The height difference or the height of the projecting end expediently amounts to between 0.5 and 3 mm, in particular between 0.8 and 2.5 mm. This embodiment with a projecting end of the cover is based on the knowledge that, in the case of a fall of the container on the cover, the force acting from the container contents can be diverted via the cover, for example onto a retention ring of a transport and/or storage container surrounding the container. In this way, the side wall and the closure system is not additionally loaded in the case of a fall of the container on the cover. Very particular importance is attributed to this embodiment within the scope of the invention. In principle, it is however also possible that the cover upper face of the cover is flush with the upper end of the side wall when the cover is placed on the side wall, and in particular is placed with its support shoulder on the support ledge of the side wall. It is possible that the cover comprises a bevel or slanted face running around the face of the cover at its cover underside facing the container interior in the outer edge in the cover underside, which bevel or slanted face is preferably provided between the cover underside and the cover outer edge. The bevel or slanted face facilitates the introduction of the cover into the side wall.

According to a particularly preferred embodiment of the invention, at least two, in particular at least three, preferably at least four, preferably at least five latch recesses are provided in the outer edge of the upper face of the cover, which are expediently distributed around the face of the cover, preferably distributed uniformly, and in which particularly preferably at least one respective latch element is provided or can be provided. A particularly recommended embodiment of the container according to the invention is characterised in that a plurality of latch recesses, in particular at least six, preferably at least eight, preferably at least ten, particularly preferably at least twelve and very particularly preferably at least fourteen latch recesses are provided in the outer edge of the upper face of the cover that are distributed around the face of the cover, preferably distributed uniformly, and in which particularly preferably at least one respective latch element is provided or can be provided. In principle, it lies within the scope of the invention that a latch element is not provided in every latch recess, so that empty latch recesses can in principle remain.

It is recommendable that the side wall comprises at least two, in particular at least three, preferably at least four, preferably at least five complementary seats that are distributed around the face of the side wall, preferably distributed uniformly. According to a particularly recommended embodiment, the side wall comprises a plurality of complementary seats, in particular at least six, preferably at least eight, preferably at least ten, particularly preferably at least twelve and very particularly preferably at least fourteen complementary seats that are distributed around the face of the side wall, preferably distributed uniformly. It lies within the scope of the invention that the number of complementary seats of the side wall corresponds to the number of latch recesses and/or the latch elements and thus the number of form fitting projections formed on the latch elements. In principle, however, it is also possible that the number of latch recesses is greater than or less than the number of complementary seats.

It is preferable that the least one form fitting projection is formed integrally on the latch element. The at least one form fitting projection is expediently constituted as an integrally formed projection on the latch element jutting out in the direction of the side wall. It lies within the scope of the invention that the latch element with the form fitting projection formed thereon is constituted L-shaped or essentially L-shaped in cross-section. It is recommended that the horizontal section of the L-shape then forms the form fitting projection or comprises the form fitting projection. According to a preferred embodiment of the invention, the at least one form fitting projection is constituted as a rectangular projection jutting out in plan view, preferably as a rectangular projection with rounded corners.

According to a very preferred embodiment of the invention, the latch recess is constituted open at least in sections towards the cover outer edge or the side wall, preferably constituted open towards the cover outer edge at least in the region corresponding to the form fitting projection of the latch element and preferably constituted open along its entire vertical height or essentially along its entire vertical height towards the cover outer edge. The at least one latch recess is expediently designed as a milling groove constituted open towards the cover outer edge. Particularly preferably, the at least one latch recess is constituted L-shaped in cross-section, and the open side of the L-shape expediently extends toward the cover outer edge. The latch recess constituted open at least in sections towards the cover outer edge or towards the side wall in particular enables the form fitting projection of the at least one latch element to be able to project in the form fitting position over the cover outer edge and to be able to enter into a form fitting interaction with the complementary seat of the side wall.

A very recommended embodiment of the invention is characterised in that the at least one complementary seat is constituted as a form fitting aperture engaging through the side wall. In this connection, it lies within the scope of the invention that the at least one form fitting projection in the latched state of the cover does not project beyond the outer face of the side wall and in particular is flush with the outer face of the side wall. Within the scope of such an embodiment, the form fitting projection of the at least one latch element engages in the form fitting position in the complementary seat of the side wall and does not project beyond the outer edge of the side wall or is flush with the outer edge of the side wall.

According to the invention, a form fitting connection between the cover and the side wall can be produced by the latch element or the latch elements. It lies within the scope of the invention that sealing measures for the sealing between the cover and the side wall are additionally provided. It is preferable that at least one main seal is provided between the cover and the side wall. It is recommended that the main seal runs at least partially, preferably completely or essentially completely, around the inner face of the side wall. The at least one main seal is preferably constituted as a seal ring running around an inner face of the side wall and/or an outer face of the side wall completely or essentially completely. It is recommended that the at least one main seal is a metal seal that is preferably constituted on the basis of at least one metal and in particular consists or essentially consists of at least one metal. Particular importance is attached to this embodiment within the scope of the invention. In principle, it is also possible that the at least one main seal is constituted on the basis of at least one plastic, for example on the basis of at least one elastomer plastic and in particular consists or essentially consists of at least one elastomer plastic.

It has been shown to be good practice for the at least one main seal to extend across, in particular perpendicular to the longitudinal central axis of the container, preferably radially of the container beneath the at least one latch element. According to a particularly recommended embodiment, the at least one main seal extends both in the direction obliquely, in particular perpendicular to the longitudinal central axis of the container, preferably radially of the container, as well as in the axial direction of the container beneath the at least one latch element. Within the scope of the invention, the axial direction of the container relates in particular to the vertical upright state of the container and expediently to the longitudinal central axis of the container. This embodiment is based on the knowledge that a geometrically compact solution to the sealing arrangement can be achieved by the transversely extending main seal, in particular perpendicular to the longitudinal central axis, preferably radially of the container beneath the at least one latch element and/or axially beneath the at least one latch element. With the measures known from practice, the seal is usually radially offset relative to the latch elements or screw fasteners.

It is preferable that the cover comprises a main sealing shoulder running around the outer face of the cover, beneath which the at least one main seal is held in the completely closed state of the container. A main seal ledge is expediently provided on the side wall, running around the inner face of the side wall. According to a preferred embodiment of the invention, the at least one main seal is provided or interposed between the main seal ledge of the side wall and the main seal shoulder of the cover. The main seal ledge of the side wall is expediently located in the upper edge of the side wall and in particular in the axial direction of the container beneath the at least one complementary seat. The main seal shoulder of the cover is located in particular in the axial direction of the container beneath the at least one latch recess of the cover. It is possible that the main seal shoulder and the main seal ledge are constituted as a separate main seal shoulder and a separate main seal ledge.

According to an alternative preferred embodiment, it lies within the scope of the invention that the main seal ledge and/or the main seal shoulder correspond to the support ledge and/or support shoulder for supporting the cover on the side wall. In the context of such an embodiment, it is preferable that the support ledge comprises an outer region radially of the container for the main seal and an inner region radially of the container that in particular is interrupted in sections and on which the cover can be placed with the complementary support shoulder. An additional main seal shoulder of the cover is then expediently provided, so that the main seal is interposed between the radially outer region of the support ledge and the main seal shoulder.

Furthermore, it lies within the scope of the invention that at least one auxiliary seal or test seal is provided that runs, in particular completely, around the cover and is preferably constituted as a test seal ring. The at least one test seal is expediently provided in a test seal groove. It has proved to be good practice that the test seal groove is formed in the cover, is preferably formed in the cover outer edge, and preferably runs around the outer face of the cover and is constituted open in the direction of the cover outer edge or the side wall. It is recommended that the at least one test seal and the corresponding test seal groove extends in the axial direction of the container above the main seal and below the at least one latch recess. It is recommended that the at least one test seal is formed on the basis of at least one plastic, in particular an elastomeric plastic.

A preferred embodiment of the invention is characterised in that the at least one latch element in the latched state of the cover is flush at its side corresponding to the cover outer edge or the side wall with the cover outer edge and expediently interacts with the inner face of the side wall, preferably abuts against the inner face of the side wall. In the context of this embodiment, it recommended that the at least one latch element in the latched state of the cover or in the completely closed state of the container lies at its side corresponding to the cover outer edge or the side wall in direct contact with the inner face of the side wall. In principle, however, it lies within the scope of the invention that an intermediate element is provided between the at least one latch element and the side wall. The side of the latch element corresponding to the cover outer edge or the side wall is understood here to mean in particular a section of the latch element that is not provided with a form fitting projection. In the case of the preferably provided formation of the latch element in an L-cross section, the vertical section of the L-shape then expediently abuts against the inner face of the side wall and the horizontal section of the L-shape expediently comprises the form fitting projection.

As has already been explained above it is recommended that the cover is connected with the side wall in a form fitting manner in its latched state or in the completely closed state of the container on account of the form fitting interaction of the at least one form fitting projection with the at least one complementary seat. At least one holding element is expediently provided in the at least one latch recess that holds the latch element in its form fitting position in the completely closed state of the container. The at least one holding element is preferably provided, in particular in a form fitting manner, preferably fitted, between the latch element and a stop shoulder of the latch recess.

When the latch element according to a preferred embodiment of the invention has been transferred into its form fitting position and has been or is displaced in particular in the direction of the container outer side by displacement obliquely, in particular perpendicular to the longitudinal central axis of the container, preferably radially of the container, a gap is preferably provided between the latch element and the stop shoulder of the latch recess. The stop shoulder expediently forms the rear-side termination of the latch recess in the direction obliquely, in particular perpendicular to the longitudinal axis, preferably in the radial direction from the container outer side to the container inner side. It is recommended that the at least one holding element is provided in the gap between the rear side of the latch element and the stop shoulder or is provided in this gap in the completely closed state of the container, in particular in a complementary tight fit. It has been shown to be successful in practice that the at least one holding element in the completely closed state to the container extends in the direction from the container outer side to the container inner side behind at least one latch element. The at least one holding element is expediently fixed in the latch recess, for example fixed by screwing, in the completely closed state of the container. For the reopening of the container, at least one holding element can be removed again from the latch recess and the latch elements can be move between the form fitting position into their open position.

According to a very preferred embodiment of the container according to the invention, the at least one latch element comprises a receptacle, preferably a locating bore, for a fixing element, in particular for a screw. It is recommended that the receptacle or the locating bore comprises an inner thread for holding the fixing element or the screw. The fixing element of the screw is preferably introduced, preferably screwed into the receptacle or locating bore in the closed state of the container. The fixing element or the screw can for example be constituted as a cover screw, as a threaded bolt, as a grub screw or suchlike. The receptacle or locating bore and/or the fixing element engage or engage through the latch element expediently in the axial direction of the container. It is recommended that at least one receptacle or locating bore extends in the axial direction of the container, when the at least one latch element is in the at least one latch recess. If, according to a preferred embodiment, the receptacle or locating bore engages through, in particular engages completely through, the latch element in the axial direction of the container, the fixing element or the screw can engage through or completely engage through the receptacle or locating bore in the completely closed state of the container. It then lies within the scope of the invention that the fixing element interacts with a floor of the latch recess and in particular exerts force on the floor of the latch recess. It is recommended, during the screwing-in of the fixing element or the screw, for the rotational movement to be converted into a straight-line movement and as soon as the fixing element or the screw makes contact with the floor of the latch recess, a force or axial force expediently acts on the floor of the latch recess. It is preferable that the force exerted by the fixing element or the screw on the floor of the latch recess fixes the latch element in its form fitting position and/or subjects to force or presses and in particular subjects to axial force the at least one main seal of the container. An excellent sealing function of the main seal results from this exertion of force or pressing.

It is preferable that a supporting foot is provided at the side of the fixing element corresponding to a floor of the latch recess. The supporting foot is preferably provided in the completely closed state of the container between the fixing element and the floor of the latch recess and interacts in particular with the floor of the latch recess. The supporting foot provided recommendably at the side of the fixing element corresponding to the floor of the latch recess thus expediently serves for the force transfer between the force or axial force exerted by the fixing element on the floor of the latch recess and provides in particular for a better distribution of this force. The supporting foot is thus expediently interposed between the end of the fixing element and the floor of the latch recess. It has proved to be good practice that the supporting foot is in direct contact with the floor of the latch recess. In principle, however, an intermediate element could be provided between the supporting foot and the floor of the latch recess. The force or axial force preferably acting on the floor of the latch recess by the fixing element or the screw with the supporting foot provided thereon preferably fixes the latch element in its form fitting position and/or expediently presses the main seal of the container. It is preferable that the main seal extends in the direction obliquely, in particular perpendicular to the longitudinal axis of the container, preferably radially of the container beneath the fixing element and in particular beneath the supporting foot, and is thus particularly preferably subjected to axial force. This embodiment is based on the knowledge that within the scope of the invention the seal between the cover and the side wall is subjected to an axial force almost exclusively or exclusively. This enables a very compact design of the container according to the invention. As a result of the design of the latch element according to the invention with the least one fixing element, however, an excellent pressing of the main seal can take place and an excellent sealing function results therefrom.

According to the invention, a form fitting connection is provided between the cover and the side wall. According to a very preferred embodiment of the container according to the invention, the cover in the completely closed state of the container is connected to the side wall free from weld joints.

According to a particularly preferred embodiment of the invention, the ratio of the diameter d of the container to the wall thickness s of the side wall amounts to at least 20:1, preferably at least 40:1, preferably at least 60:1, particularly preferably at least 80:1, and very particularly preferably at least 100:1, for example at least 120:1. It is recommended that the ratio of the diameter d of the container to the wall thickness s of the side wall amounts to between 40:1 and 100:1 preferably between 50:1 and 95:1, preferably between 60:1 and 90:1. Diameter d of the container is understood within the scope of the invention to mean in particular the largest diameter of the container obliquely, in particular perpendicular to the longitudinal axis of the container. Wall thickness s of the side wall is understood in this connection to mean in particular the wall thickness of the side wall in the region below the cover arrangement, so that ledges formed at the inner face in the region of the cover arrangement do not count towards the wall thickness of the side wall. In the region beneath the cover arrangement, the wall thickness of the side wall is then understood to mean in particular the greatest wall thickness of the side wall.

For the solution to the technical problem, the invention further teaches a container assembly unit with a container described above and a transport and/or storage container, the container is a canister loaded with spent fuel elements that is received in the transport and/or storage container, and the transport and/or storage container can be closed or is closed with at least one primary cover and can or is also expediently closed with a secondary cover provided over the primary cover. It is recommended that the canister is loaded with the spent fuel elements under water, and the fuel elements are received by a carrier basket provided in the canister. The canister is then expediently transferred by a transfer container to the transport and/or storage container and introduced into the transport and/or storage container and recommendably handled vertically. The transport and/or storage container is then preferably closed with the primary cover and the secondary cover and fed to an intermediate storage or final storage.

In principle, it is also possible that the container according to the invention is already a transport and/or storage container, and the cover is then the primary cover of the transport and/or storage container. It is recommended that the primary cover is fixed in a form fitting manner on the side wall of the transport and/or storage container using the measures according to the invention. The transport and/or storage container is expediently closed with an additional secondary cover following the form fitting connection of the primary cover.

The invention is based on the knowledge that the container according to the invention can be closed easily and functionally safely on account of the measures according to the invention and can in fact be closed in particular on account of the form fitting interaction of the form fitting projections with the complementary seats. The connection between the cover and the side wall is advantageously constituted free from weld joints. If the container is a canister for example, handling of the canister with little effort is however possible. Furthermore, the container according to the invention is characterised in that the connection between the cover and the side wall also withstands the loads during the transfer of the canister for example into a transport and/or storage container without problem. Furthermore, it should be emphasized that the connection between the cover and the side wall can be reopened without problem. Destruction-free reopening of the container or canister is thus possible. This is achieved by the capability of the at least one latch element to be move between a form fitting position into an open position and in particular by the preferably provided displaceability of the at least one latch element in the at least one latch recess. In the form fitting position of the latch element, the connection between the cover and the side wall is produced on account of the form fitting interaction. In the open position of the latch elements, opening of the container or canister is possible by removal of the cover. When the at least one latch element is located in the form fitting position, the latch element can be held or fixed in this form fitting position by at least one holding element and/or at least one fixing element, so that a complete and secure closure of the container can be implemented. The at least one holding element can expediently be removed again from the latch recess and the transfer of the at least one latch element from the form fitting position into the open position is then again possible. It should furthermore be stressed that the measures according to the invention are advantageous in particular for containers or canisters with a small wall thickness compared to the diameter. Such containers or canisters do not have sufficient wall thickness for a seal provided radially offset with respect to the latch mechanisms. Within the scope of the invention, the least one seal is provided in the direction obliquely, in particular perpendicular is to the longitudinal axis of the container, preferably radially of the container beneath the latch element and in particular beneath the fixing element preferably provided in the latch element. In this way, the seal is subjected to an axial force exerted by the fixing element and a sealing of the container or canister that meets all the requirements is thus advantageously achieved in a very space-saving manner. The sealing is preferably solely or essentially solely subjected to an axial force.

The container or canister according to the invention thus meets all the requirements with regard to its tightness and its stability with respect to mechanical loads, for example during the transport or the transfer of the canister, and nonetheless can be closed or opened at will without great effort and in particular destruction-free. The measures according to the invention, moreover, are implemented with relatively little expenditure, so that for the production and also the use of the container or canister is very economical.

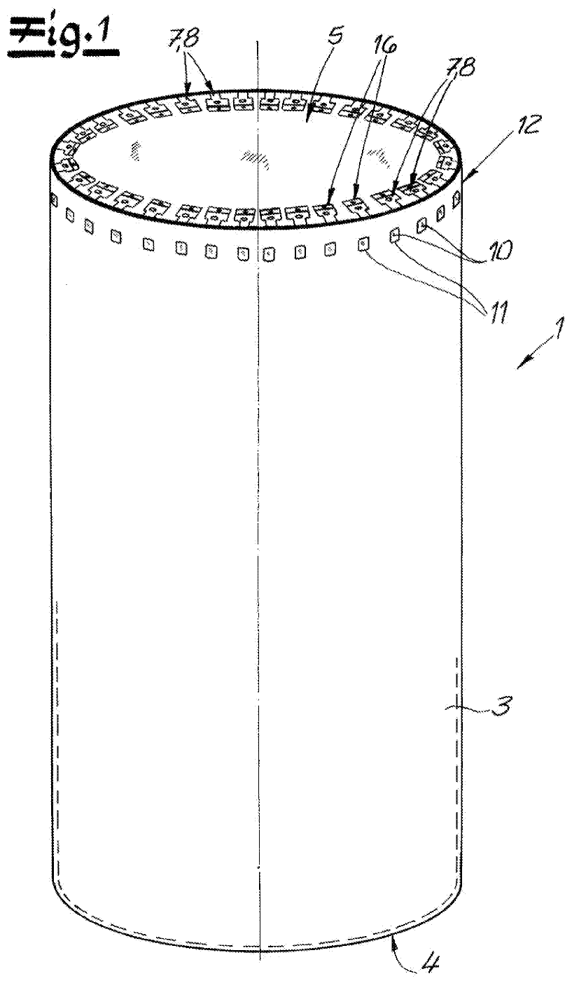

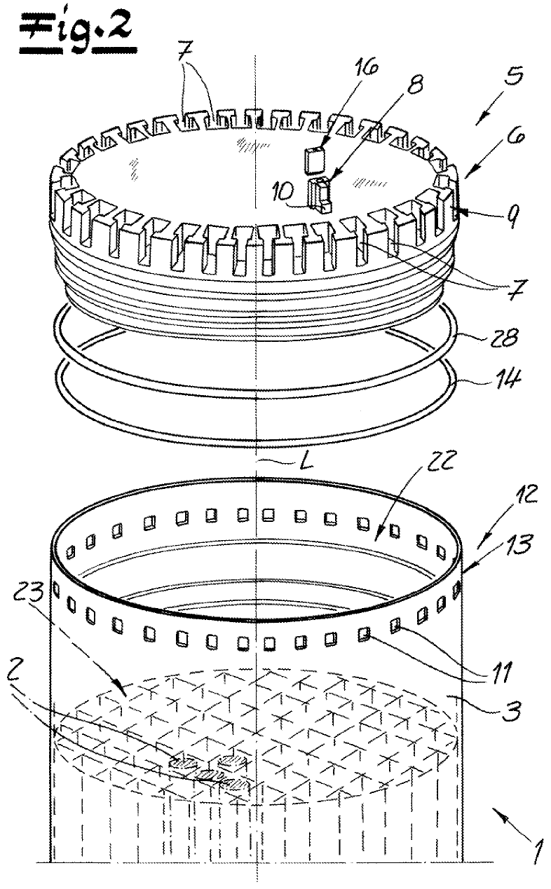

FIG. 1 is a perspective view of a container according to the invention

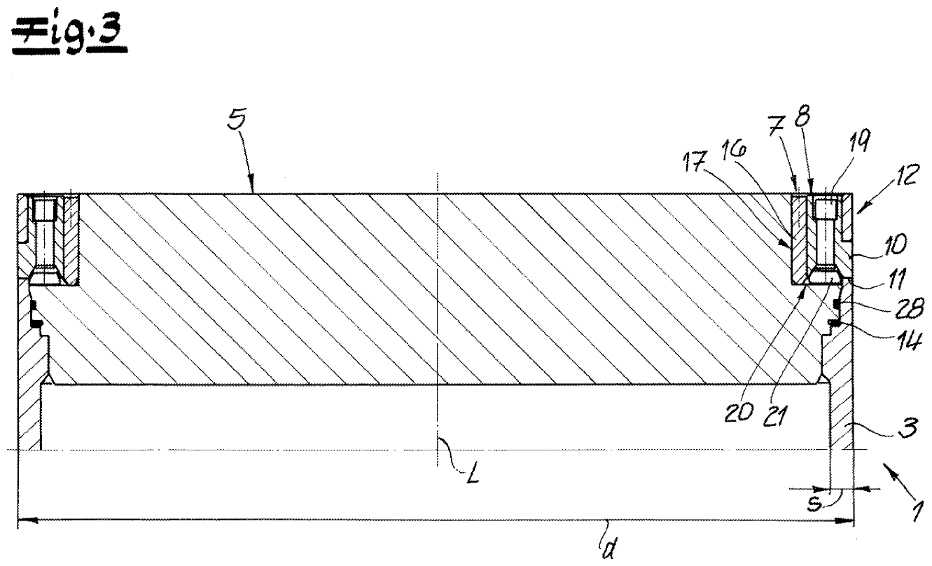

FIG. 2 shows a detail from FIG. 1 as a perspective exploded view,

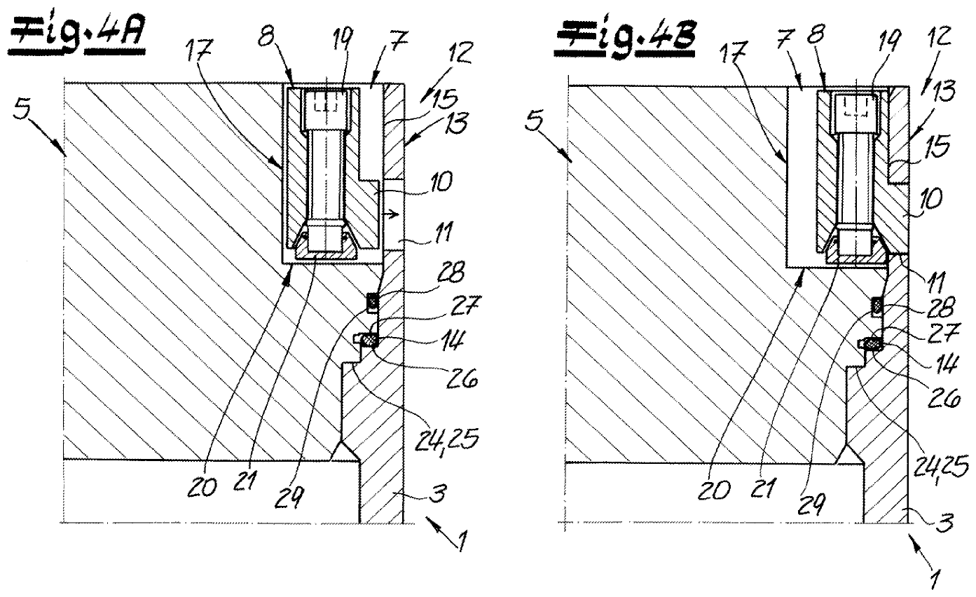

FIG. 3 is a longitudinal cross-section through the container according to the invention in the completely closed state,

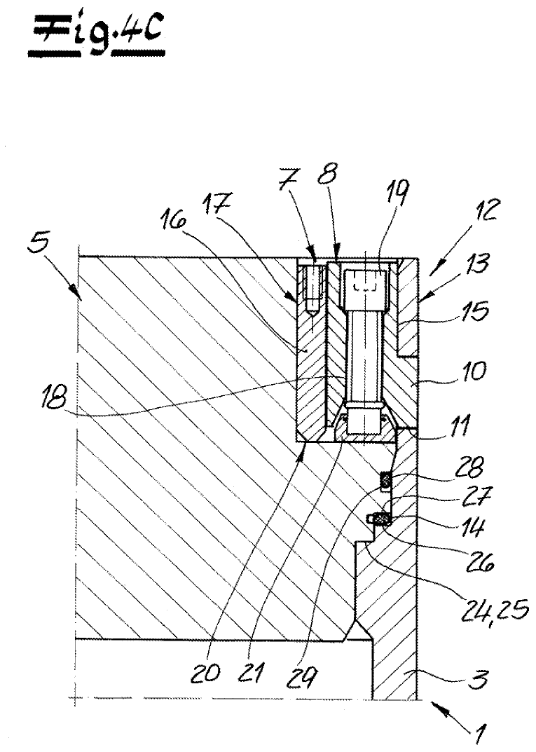

FIG. 4A shows a detail of the container in cross-section in the unlatched state of the cover,

FIG. 4B shows the container according to FIG. 4A when the cover is latched, and

FIG. 4C shows the container according to FIG. 4A in the completely closed state of the container.

The drawing show a container 1 for holding radioactive waste materials, expediently and in the example of embodiment for holding spent fuel elements 2. Container 1 comprises a container side wall 3, a floor 4 connected to container side wall 3 and a cover 5. Preferably and in the example of embodiment according to the drawing, cover 5 comprises latch recesses 7 formed in the outer edge 6 of the upper face of the cover, in which a respective latch element 8 is provided. Latch elements 8 each comprise at least one form fitting projection 10 extending toward the cover outer edge 9 or container side wall 3. In the latched state of cover 5, form fitting projections 10 each engage in a complementary seat 11 of container side wall 3 (e.g. FIGS. 1, 3, 4B, 4C). Complementary seats 11 are formed in outer edge 12 of container side wall 3 in the cover side. Container 1 represented in the drawing is a canister.

The term latched state of cover 5 is understood within the scope of the invention to mean in particular the state in which form fitting projections 10 of latch elements 8 engage in complementary seats 11 of container side wall 3, so that a form fitting interaction between form fitting projections 10 and complementary seats 11 is achieved. Expediently and in the example of embodiment, cover 5 in this latched state is connected to container side wall 3 in a form fitting manner in particular by latch elements 8 on account of the form fitting interaction.

Within the scope of the invention and in the example of embodiment, a carrier basket 23 for holding spent fuel elements 2 is provided in container interior 22 of container 1. Expediently and in the example of embodiment, container 1 is constituted cylindrical and it is recommended that it has a circular cross-section.

Expediently and in the example of embodiment according to the drawing, latch elements 8 in the unlatched state of container 1 is can be displaced radially with respect to longitudinal central axis L of container 1 in latch recesses 7. Preferably and in the example of embodiment, latch elements 8 can thus be move between an open position into a form fitting position and back (FIGS. 4A, 4B). Unlatched state of container 1 is understood in this connection to mean in particular that latch elements 8 are not yet completely fixed in their form fitting position (FIGS. 4A, 4B). In contrast, completely closed state of container 1 is expediently understood to mean the state in which cover 5 is connected in a form fitting manner with container side wall 3 in particular by latch elements 8 and in which latch elements 8 are fixed in their form fitting position (1, 3, 4C). By the displacement of latch elements 8 radially with respect to longitudinal central axis L of container 1, latch elements 8 can preferably, and in the example of embodiment, be move between an open position into a form fitting position and back. In the open position (FIG. 4A), it is recommended that form fitting projections 10 of latch elements 8 do not engage in complementary seats 11 of container side wall 3. Cover 5 is then provided in the unlatched state. In the form fitting position, form fitting projections 10 of latch elements 8 engage in a form fitting manner in complementary seats 11 and are then located in their form fitting position after the displacement of latch elements 8 in latch recesses 7 in the direction of the container outer side (FIG. 4B). Cover 5 is then located in the latched state. In principle, container 1 can already be in the completely closed state by the transfer of latch elements 8 into the form fitting position and thus in the latched state of cover 5. Preferably and in the example of embodiment according to the drawing, however, additional holding elements 16 and fixing elements 19 are provided that hold or fix latch elements 8 in their form fitting positions and produce the completely closed state of container 1. (FIGS. 1, 3, 4C).

Expediently and in the example of embodiment according to the drawing, container 1 comprises a support ledge 24 running around the inner face of container side wall 3, on which cover 5 is placed. Preferably and in the example of embodiment, support ledge 24 is formed in side edge 12 of container side wall 3 on the cover side and beneath complementary seats 11. Recommendably and in the example of embodiment, cover 5 comprises a complementary support shoulder 25 for supporting on a support ledge 24. This can for example be seen in FIG. 4A.

Distributed over the face of cover 5—preferably and in the example of embodiment distributed uniformly—a plurality of latch recesses 7 is provided in outer edge 6 of the upper face of the cover, preferably and in example of embodiment at least fourteen latch recesses 7. Preferably and in the example of embodiment, a respective latch element 8 is provided each of the at least fourteen latch recesses 7. Accordingly, a plurality of complementary seats 11, preferably at least fourteen complementary seats 11, is also provided, and complementary seats 11 are distributed over the surface of container side wall 3, in particular and in the example of embodiment uniformly distributed. Recommendably and in the example of embodiment, form fitting projections 10 are formed integrally on latch elements 8 and each formed as a projection jutting out in the direction of the side wall 3. Preferably and in the example of embodiment, latch elements 8 with form fitting projections 10 formed thereon are constituted L-shaped in cross-section (FIG. 3). In the example of embodiment in one view, form fitting projections 10 are constituted as rectangular projections with rounded corners (FIG. 2).

According to a very recommended embodiment and in the example of embodiment, latch recesses 7 are constituted open along their entire vertical height or essentially along their entire vertical height towards the cover outer edge 9 or towards container side wall 3. This can be seen for example in FIGS. 2 and 3. Latch recesses 7 are thus expediently constituted L-shaped or essentially L-shaped in cross-section, and the open side of the L-shape extends toward the cover outer edge 9. Preferably and in the example of embodiment, complementary seats 11 are constituted as form fitting apertures engaging through container side wall 3. In the latched state of cover 5, form fitting projections 10 do not project beyond outer side 13 of container side wall 3 and recommendably, and in the example of embodiment, are flush with outer side 13 of container side wall 3. This can be seen in particular in FIG. 4B.

Recommendably and in the example of embodiment, additional sealing measures for the sealing between cover 5 and container side wall 3 are also provided. Expediently and in the example of embodiment, at least one main seal 14 is provided for this purpose between container side wall 3 and cover 5 that in the example of embodiment according to the drawing is constituted as a seal ring running completely around the inner face of container side wall 3 and the outer face of cover 5. Main seal 14 is expediently a metal seal that is preferably constituted on the basis of at least one metal. It is preferable that main seal 14 extends radially of container 1 beneath latch elements 8. In the example of embodiment according to the drawing, main seal 14 is also provided in addition in the axial direction of container 1 beneath latch elements 8. This is represented for example in FIGS. 3 and 4A to 4C. Preferably and in the example of embodiment according to the drawing, main seal 14 is provided or interposed between a main seal ledge 26 of container side wall 3 and a main seal shoulder 27 of cover 5. Preferably and in the example of embodiment, test seal 28 is also provided that is constituted as a is test seal ring and is expediently provided in a test seal groove 29 that is provided in the axial direction of container 1 above main seal 14 and beneath latch elements 8.

Particularly preferably and in the example of embodiment, latch elements 8 in the latched state of cover 5 abut at their side corresponding to cover outer edge 9 and container side wall 3 against an inner side 15 of container side wall 3 (FIG. 4B). According to a very particularly preferred embodiment of container 1 according to the invention, a holding element 16 is provided in each of latch recesses 7 that holds latch elements 8 in their form fitting position in the completely closed state of container 1 and is provided between latch elements 8 and a stop shoulder 17 of latch recesses 7, expediently and in the example of embodiment is fitted snugly. In the form fitting position of latch elements 8, a respective gap is formed between each latch element 8 and stop shoulder 17 of latch recess 7 (FIG. 4B). Stop shoulder 17 expediently forms the rear-side termination of latch recess 7 in the radial direction from the container outer side to the container inner side. Expediently and in the example of embodiment (FIGS. 3 and 4C), a respective holding element 16 is provided or fitted in a form fitting manner in each gap between the rear side of latch element 8 and stop shoulder 17. Recommendably and in the example of embodiment, holding elements 16 in the completely closed state of the container (FIGS. 1, 3, 4C) thus extend from the container outer side to the container inner side behind latch elements 8. In the example of embodiment according to the drawing, moreover, holding elements 16 in the completely closed state of the container are fixed in latch recesses 7 by a screw connection. To reopen container 1, holding elements 16 can be removed again from the latch recesses. Latch elements 8 can then be brought from the form fitting position into the open position.

According to a particularly preferred embodiment of container 1 according to the invention and in the example of embodiment, latch elements 8 each comprise a locating bore 18 for a fixing element 19. Preferably and in the example of embodiment, locating bores 18 extend in the axial direction of container 1 when latch elements 8 are provided in respective latch recesses 7. In the example of embodiment according to the drawing, fixing element 19 is constituted as a screw. In the completely closed state of the container, fixing element 19 is expediently screwed into locating bore 18. Recommendably and in the example of embodiment, fixing element 19 and locating bore 18 engage through latch element 8 or completely engage through latch element 8. Furthermore, it is preferable that a respective supporting foot 21 is provided at each side of the fixing elements 19 corresponding to a floor 20 of latch recess 7. Recommendably and in the example of embodiment, these supporting feet 21 are provided between fixing elements 19 and respective floor 20 of latch recesses 7 in the completely closed state of container 1 and interact in particular with floor 20 of latch recesses 7. When fixing element 19 or the screw is screwed in, the rotational movement is converted into a straight-line movement and as soon as supporting foot 21 of fixing element 19 contacts floor 20 of respective latch recess 7, an axial force acts on floor 20 of latch recess 7 that preferably holds latch element 8 in the form fitting position and, preferably and in the example of embodiment, exerts a force on or presses main seal 14 of container 1 (FIGS. 3, 4C). Supporting foot 21 serves for the uniform force transfer onto floor 20 of latch recess 7. Preferably and in the example of embodiment, main seal 14 is moreover extend radially of container 1 beneath supporting foot 21 and is thus expediently subjected to an axial force by supporting foot 21. In the completely closed state of container 1, cover 5 is connected to container side wall 3 free from weld joints. For reopening of container 1, fixing elements 19 are unscrewed or at least partially unscrewed again from locating bores 18.

The ratio of diameter d of container 1 to wall thickness s of the side wall 3 expediently amounts to at least 40:1 and in the example of embodiment according to the drawing, the ratio d/s can amount to at least 45:1 (FIG. 3). Diameter d of container 1 is understood here to mean in particular the greatest diameter of container 1, obliquely, in particular perpendicular to longitudinal axis L of container 1. Wall thickness s of container side wall 3 is understood in this connection to mean in particular the wall thickness of container side wall 3 in the region beneath the cover arrangement, so that ledges formed at the inner face, for example supporting ledge 24, and main seal ledge 26 do not count towards the wall thickness of container side wall 3. In the region beneath the cover arrangement, wall thickness of container side wall 3 is then understood to mean in particular the greatest wall thickness of container side wall 3.

1-17. (canceled)

18. A container for holding radioactive waste materials comprising:
a container side wall generally centered on an upright axis;
a floor downwardly closing the side wall;
a cover having an upper face formed at an outer edge of the cover with a latch recess; and
a latch element fittable in the latch recess and having a projection that extends toward the side wall and that engages in a complementary seat of the side wall in a latched state of the cover, the complementary seat being formed in the upper edge of the side wall and being constituted as a form fitting aperture extending through the side wall.

19. The container according to claim 18, wherein the latch element in the unlatched state of the container can be displaced radially of the axis into the latch recess so that it can be moved between an unlatched position disengaged from the seat into a latched position fitting complementarily into the seat.

20. The container according to claim 18, wherein at least two of the latch recesses are provided distributed angularly around the outer edge of the upper face of the cover and in each of a respective latch element can fit.

21. The container according to claim 20, wherein the side wall comprises at least two of the complementary seats that are distributed angularly around the upper edge of the side wall.

22. The container according to claim 18, wherein the form fitting projection is formed integrally on the latch element and projects radially outward of the axis from the latch element.

23. The container according to claim 18, wherein the latch recess opens upward on the upper face of the cover at the cover outer edge and is radially outwardly open along its entire vertical height.

24. The container according to claim 18, wherein the form fitting projection in the latched state of the cover does not project in the latched state beyond a radial outer face of the side wall and is flush with the outer face of the side wall.

25. The container according to claim 18, further comprising:
a main seal between the side wall and the cover, around the inner face of the side wall, and across the axis of the container radially of the container beneath the latch element.

26. The container according to claim 18, wherein the latch element in the latched state of the cover is flush at its side corresponding to the cover outer edge or the side wall with the cover outer edge and expediently interacts with and abuts against the inner face of the side wall.

27. The container according to claim 18, further comprising:
a fixing element in the latch recess that holds the latch element in its form fitting position in the completely closed state of the container and mounted in a complementary and snug fit between the latch element and a stop shoulder of the latch recess.

28. The container according to claim 18, wherein the latch element is formed with a locating bore for a screw fastener screwed into the locating bore in a completely closed state of the container, and the bore and/or the fastener expediently engages axially through the latch element.

29. The container according to claim 27, further comprising:
a supporting foot at a lower end of the fixing element and engageable with a floor of the latch recess, the supporting foot in the completely closed state of the container being braced between the fixing element and the floor of the latch recess.

30. The container according to claim 18, wherein the cover in the completely closed state of the container is connected to the side wall free from weld joints.

31. The container according to claim 18, wherein
a ratio of a diameter of the container to a wall thickness of the side wall amounts to at least 20:1.

32. The container according to claim 18, further comprising:
a support basket for holding spent fuel elements on the floor inside the side wall that is cylindrically tubular.

33. The container according to claim 18, further comprising:
a secondary cover over the primary cover.
